(19) United States
(12) Patent Application Publication
(10) Pub. No.: US 2004/0211814 A1
(43) Pub. Date: Oct. 28, 2004

(54) Wire bonding capillary for an image sensor

(76) Inventors: Jackson Hsieh, Hsinchu Hsien (TW); Jichen Wu, Hsinchu Hsien (TW); Bruce Chen, Hsinchu Hsien (TW); Eric Chang, Hsinchu Hsien (TW); Worrell Tsai, Hsinchu Hsien (TW); Abnet Chen, Hsinchu Hsien (TW); Jr-Shuen Yang, Hsinchu Hsien (TW)

Correspondence Address: Keith Kline, PRO-TECHTOR INTERNATIONAL SERVICES, 20775 Norada Court, Saratoga, CA, 95070-3018, US

(21) Appl. No.: 10/422,203

(22) Filed: Apr. 23, 2003

(51) Int. Cl. B23K 31/02

(52) U.S. Cl. 228/4.5; 228/180.5

(57) ABSTRACT

A wire bonding capillary includes a first column having a first end and a second end, a second column extending from the second end of the first column and having a circular cross-section with a diameter smaller than that of the first column, and a third column extending from the second column and formed with a funnel structure and a pointed wire-bonding end. The third column is positioned between a frame layer and a photosensitive chip of an image sensor to bond a plurality of wires to a photosensitive chip and a substrate of the image sensor.

### BACKGROUND OF THE INVENTION

1. Field of the Invention

The invention relates to a wire bonding capillary for an image sensor, and more particularly to a wire bonding capillary capable of increasing the throughput and reducing the package volume of the image sensor.

2. Description of the Related Art

A general sensor is used to sense signals, which may be optical or audio signals. The sensor of the invention is used to receive image signals or optical signals. After receiving the image signals, the sensor converts the image signals into electrical signals, which are then transmitted to a printed circuit board via a substrate.

Referring to FIG. 1, a conventional image sensor includes a substrate 10, a frame layer 12, a photosensitive chip 14, a plurality of wires 15, and a transparent layer 22. The substrate 10 has an upper surface 11 on which signal input terminals 18 are formed, and a lower surface 13 on which signal output terminals 24 are formed. The frame layer 12 is arranged on the substrate 10 to form a cavity 16 together with the substrate 10. The photosensitive chip 14 is arranged on the substrate 10 and within the cavity 16. A plurality of bonding pads 20 is formed on the photosensitive chip 14. The wires 15 electrically connect the bonding pads 20 of the photosensitive chip 14 to the signal input terminals 18 of the substrate 10, respectively. The transparent layer 22 is coated with an adhesive layer 23 and arranged on the frame layer 12 to cover and encapsulate the photosensitive chip 14.

As shown in FIG. 2, a conventional wire bonding capillary for an image sensor is used to bond a plurality of wires 15 to the photosensitive chip 14 and the substrate 10. The capillary 30 includes a first column 32 and a second column 34 extending from the first column 32. As shown in FIGS. 1 to 3, when the wire bonding process is to be performed, the second column 34 has to be inserted into a gap between the frame layer 12 and the photosensitive chip 14. In this case, the first column 32 tends to hit the frame layer 12, and the image sensor may be damaged. In addition, in order to avoid the above-mentioned situation, the gap between the frame layer 12 and the photosensitive chip 14 has to be enlarged. Accordingly, the volume of the packaged image sensor cannot be effectively reduced.

### SUMMARY OF THE INVENTION

An object of the invention is to provide a wire bonding capillary for an image sensor to facilitate the wire bonding process and to increase the throughput.

Another object of the invention is to provide a wire bonding capillary for an image sensor having a reduced gap between a frame layer and a photosensitive chip. Thus, a larger chip may be used in the same wire-bonding region, or the image sensor may be miniaturized.

To achieve the above-mentioned objects, the invention provides a wire bonding capillary. The wire bonding capillary includes a first column having a first end and a second end, a second column extending from the second end of the first column and having a circular cross-section with a diameter smaller than that of the first column, and a third column extending from the second column and formed with a funnel structure and a pointed wire-bonding end. The third column is positioned between a frame layer and a photosensitive chip of an image sensor to bond a plurality of wires to the photosensitive chip and a substrate of the image sensor.

Accordingly, the third column is free from touching the frame layer. Thus, the throughput may be effectively increased.

### BRIEF DESCRIPTION OF THE DRAWINGS

FIG. 1 is a schematic illustration showing a conventional image sensor.

FIG. 2 is a pictorial view showing a conventional wire bonding capillary for an image sensor.

FIG. 3 is a schematic illustration showing the implementation of the conventional wire bonding capillary.

FIG. 4 is a pictorial view showing a wire bonding capillary for an image sensor according to the invention.

FIG. 5 is a schematic illustration showing the implementation of the wire bonding capillary for the image sensor according to the invention.

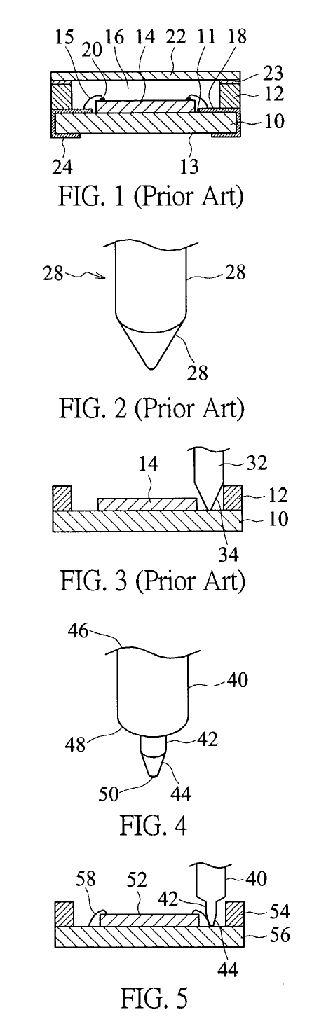

### DETAILED DESCRIPTION OF THE INVENTION

Referring to FIG. 4, a wire bonding capillary for an image sensor according to an embodiment of the invention includes a first column 40, a second column 42, and a third column 44.

The first column 40 is a cylinder having a first end 46 and a second end 48.

The second column 42 and the first column 40 have the same axis. The second column 42 is a cylinder extending from the second end 48 of the first column 40. The second column 42 has a circular cross-section having a diameter smaller than that of the first column 40.

The third column 44 is a cone extending from the second column 42 and is formed with a funnel structure and a pointed wire-bonding end 50.

As shown in FIG. 5, after a photosensitive chip 52 is mounted to a substrate 56 to which a frame layer 54 is mounted, the second column 42 and the third column 44 of the capillary may be positioned within a gap between the frame layer 54 and the photosensitive chip 52. Therefore, the second column 42 and the third column 44 cannot touch the frame layer 54 when the capillary is sequentially moved during the wire bonding process. Then, a plurality of wires 58 may be successfully bonded to the photosensitive chip 52 and the substrate 56.

The wire bonding capillary of the invention has the following advantages.

1. The capillary may facilitate the wire bonding process and effectively increase the throughput of the image sensor.

2. The gap between the photosensitive chip 52 and the frame layer 54 may be effectively reduced, and the image sensor may be miniaturized accordingly.

3. A larger photosensitive chip 52 may be used to replace a smaller photosensitive chip 52, and the additional functions of the image sensor may be enhanced.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. A wire bonding capillary, comprising:
a first column having a first end and a second end;
a second column extending from the second end of the first column and having a circular cross-section with a diameter smaller than that of the first column; and
a third column extending from the second column and formed with a funnel structure and a pointed wire-bonding end, the third column being positioned between a frame layer and a photosensitive chip of an image sensor to bond a plurality of wires to a photosensitive chip and a substrate of the image sensor.

2. The wire bonding capillary according to claim 1, wherein the first column is a cylinder.

3. The wire bonding capillary according to claim 1, wherein the second column is a cylinder.

4. The wire bonding capillary according to claim 1, wherein the first column and the second column has the same axis.

5. The wire bonding capillary according to claim 1, wherein the third column is a cone.
